(19) United States
(12) Patent Application Publication
(10) Pub. No.: US 2014/0291537 A1
(43) Pub. Date: Oct. 2, 2014

(54) AN IONIZATION CHAMBER

(71) Applicants: René Kroes, Delft (NL); Fokko Pieter Wieringa, Delft (NL); Marcus Benedictus Hoppenbrouwers, Delft (NL)

(72) Inventors: René Kroes, Delft (NL); Fokko Pieter Wieringa, Delft (NL); Marcus Benedictus Hoppenbrouwers, Delft (NL)

(73) Assignee: NEDERLANDSE ORGANISATIE VOOR TOEGEPAST-NATUURWETNS CHAPPELIJK ONDERZOEK TNO, DELFT (NL)

(21) Appl. No.: 14/001,396

(22) PCT Filed: Feb. 24, 2012
(86) PCT No.: PCT/NL2012/050111

§ 371 Date: Mar. 7, 2014

(30) Foreign Application Priority Data
Feb. 25, 2011 (EP) 11156039.7

(51) Int. Cl. G01T 1/185

(52) U.S. Cl. CPC G01T 1/185
USPC 250/374; 29/593

(57) ABSTRACT

The invention relates to an ionization chamber (10) comprising an inner spherical electrode (2), an outer spherical electrode (4), a space between the inner spherical electrode and the outer spherical electrode, and a resistive hollow body (3) provided in the said space, wherein electrical connections to the inner spherical electrode and electrical connection to the top of the resistive hollow body (3) are electrostatically shielded by that same resistive hollow body having a continuously varied local resistance along its axis. The invention further relates to a method of manufacturing an ionization chamber.

### FIELD OF THE INVENTION

The invention relates to an ionization chamber, in particular the invention relates to a spherical ionization chamber.

The invention further relates to a method of manufacturing an ionization chamber.

### BACKGROUND OF THE INVENTION

Spherical ionization chambers are known per se. For example, CN 101526622 describes a detector device for radiation monitoring, which comprises an ionization chamber part comprising a shell and an electrode part, a circuit part for processing electrical signals from the electrode part, and a metal seal box, wherein the circuit part is arranged in the metal seal box. The known spherical ionization chamber is filled with a gas in a volume between the inner electrode and the outer electrode.

Such spherical ionization chambers may be used for dosimetry purposes for enabling measurements without directional sensitivity. However, it is found that such spherical ionization chambers do demonstrate directional sensitivity in strong external magnetic fields, such as the magnetic fields present in a magnetic resonance apparatus, cyclotron or fusion reactor.

In particular, it appears that the electrical connection, necessary for providing voltage to the inner spherical electrode, distorts the otherwise spherical electrical field distribution between the inner electrode and the outer electrode.

### SUMMARY OF THE INVENTION

It is an object of the invention to provide a spherical ionization chamber for use in relatively strong magnetic fields, such as those of a magnetic resonance apparatus, wherein distortion of the E-field is avoided or is substantially mitigated.

To this end an ionization chamber according to the invention comprises an inner spherical electrode, an outer spherical electrode, a space between the inner spherical electrode and the outer spherical electrode, and a resistive hollow body provided in the said space, wherein electrical connections to the inner spherical electrode and electrical connection to the top of a resistive hollow body are electrostatically screened by that same resistive hollow body having a continuously varied local resistance along its axis.

It will be appreciated that by way of its functioning the spherical ionization chamber always comprises a necessary electrical connection to the inner electrode.

It is found that by providing a resistive body extending substantially radially between the inner surface of the outer spherical electrode and the inner spherical electrode, thereby screening the electrical connection to the inner electrode, the distortion of the E-field caused by said connection may be mitigated or substantially overcome. The continuously varied local resistance of the resistive body is adapted to mimic the spatial electrostatic potential characteristics that would be present between the charged inner spherical electrode and the outer spherical electrode. In this way the resulting ionization chamber is highly immune to magnetic fields.

To achieve this, it is clear that the electrical resistance should depend on the radius r along the resistive body. Usually such resistive body is relatively thin, i.e. comparable with he dimensions of the electrical wire used to enable electrical connection to the inner electrode. In order to derive how, we consider the system of charged conductors only, because this is exactly what has to be “mimicked” by the resistive body.

This simplifies the system to an inner charged small sphere with a radius ‘a’ at an electric potential Vₐ, being located at the centre of a larger hollow conducting sphere with inner radius ‘b’.

For a<r<b the associated electrical potential

$$V ( r ) = {V}_{a} \cdot {R}_{a} \cdot ( \frac{1 - \frac{{R}_{b}}{r}}{{R}_{a} - {R}_{b}} ) .$$

Accordingly, at a given r the local resistance of the resistive layer around a thin central pole should be inverse proportional to the distance from the centre. The electrical potential at point r along the pole can be regarded as the wiper of a potentiometer.

The power dissipation in the resistive pole should be limited. With a typical driving voltage of 1000V and a resistive pole of total 10⁷ Ω the pole current would be limited to 100 micro ampere and the dissipated power to 100 mW.

Any material to manufacture high voltage electrical resistive components according to the present art can be used. Some non-limiting examples are: carbon, metal films or slightly conductive polymers. The desired distance dependent resistance can e.g. be achieved by varying the layer thickness inversely to the distance.

It will be appreciated that those skilled in the art readily appreciate how to calculate necessary values of the varied resistance for spherical ionization chambers having different geometrical and electric characteristics.

An embodiment of a spherical ionization chamber is known from Kim H. S. et al “Performance of a high-pressure xenon ionization chamber for environmental radiation monitoring”, Radiation Measurements, Elsevier, Amsterdam, N L, vol. 43, no. 2-6, 1 Feb. 2008, pages 659-663.

The known ionization chamber describes an inner spherical electrode and an outer spherical electrode. However, a shielding mesh known used in the known ionization chamber, being a per se known Frisch grid, is intended to be operable at a single and constant potential and is manufactured from a well electrically conductive material. Accordingly, the grid shall be always at the same potential in use at a given time. In addition, it will be appreciated that the Frisch mesh is manufactured for allowing a passage of a flux of charged particles through the openings in the mesh.

It is a disadvantage of the known spherical ionization chamber that the Frisch grid, being operable at the constant potential value, introduces undesirable perturbations into the electric field in the inner volume of the ionization chamber.

In the invention, however, the resistive hollow body provided in the inner space of the spherical ionization has a variable potential along its length. Accordingly, the surrounding resistive body neutralizes any perturbation of the electric field inside the spherical ionization chamber which may occur due to the internal conductor.

In addition, it is noted that the resistive hollow body in the spherical ionization chamber of the invention may be advantageously designed to be embodied by a cylindrical or tapered hollow resistor, so that one potential along the length of the resistor varies from the value preset at the inner electrically conductive electrode to the potential value preset at the outer electrically conductive electrode. In this way the resistive body shields the inner high voltage electrode. Accordingly, charged particles in the gas volume of the ionization chamber will not be influenced by the presence of the high voltage lead field, because this field is effectively shielded by the resistive body.

In an embodiment of the ionization chamber according to the invention the resistive body has a larger dimension at its base portion on the outer spherical electrode and a smaller dimension at its top near the inner spherical electrode. Preferably, the dimension of the base is about 5 mm and the dimension of the top is about 1 mm. Due to the fact that the resistive body is adapted to restore the spherical symmetry of the E-field between the inner electrode and the outer electrode, a value of the resistance at the top of the resistive body is larger than a value of the resistance and the base of the resistive body.

In a further embodiment of the ionization chamber according to the invention, the top of the resistive body is connected to the inner spherical electrode by an insulator.

It is found to be advantageous to provide a relatively stiff connection between the top portion of the resistive body and the inner electrode for preserving radial orientation of the resistive body inside the ionization chamber.

A method for manufacturing an ionization chamber according to the invention comprises the steps of:
providing an inner spherical electrode, an outer spherical electrode, a space between the inner spherical electrode and the outer spherical electrode and a hollow resistive body in said space;
screening an electrical connection to the inner spherical electrode and to the top of the hollow resistive body using the same hollow resistive body having a continuously varied local resistance, wherein said resistive body is radially arranged in said space between an inner surface of the outer spherical electrode and the inner spherical electrode.

Further advantageous embodiments of the method according to the invention are set forth in claims 8-11.

These and other aspects of the invention will be discussed in more detail with reference to the figures, wherein like reference signs relate to like elements.

### BRIEF DESCRIPTION

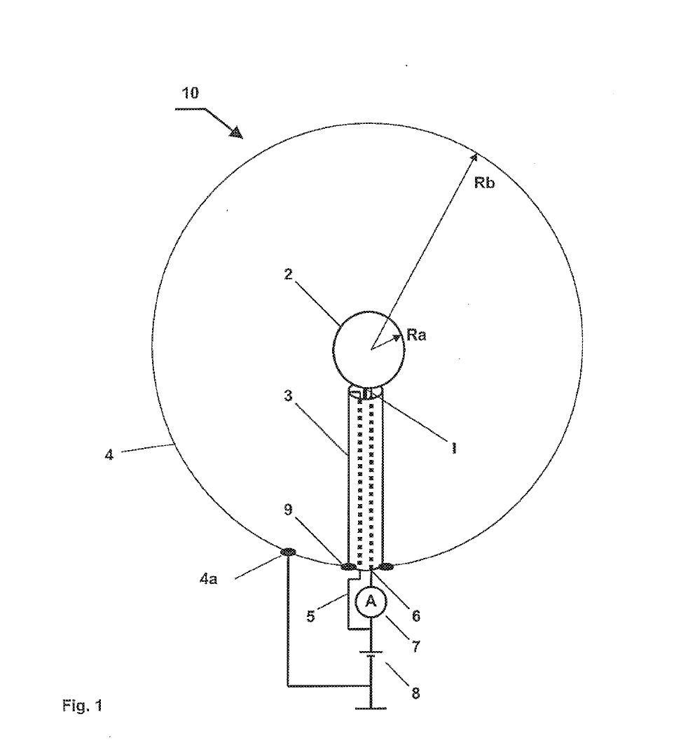

FIG. 1 presents in a schematic way an embodiment of a cross-section of the spherical ionization chamber according to the invention.

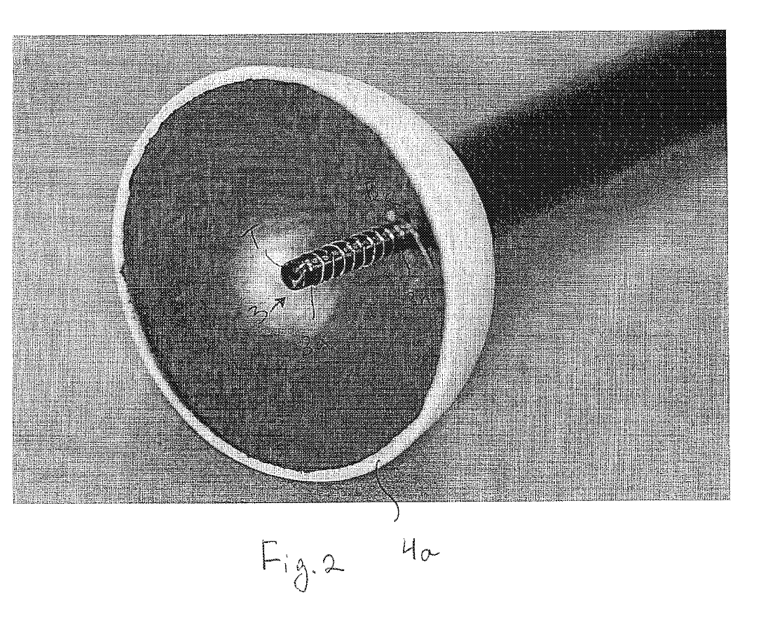

FIG. 2 presents in a schematic way an embodiment of a cut-away of the spherical ionization chamber according to the invention.

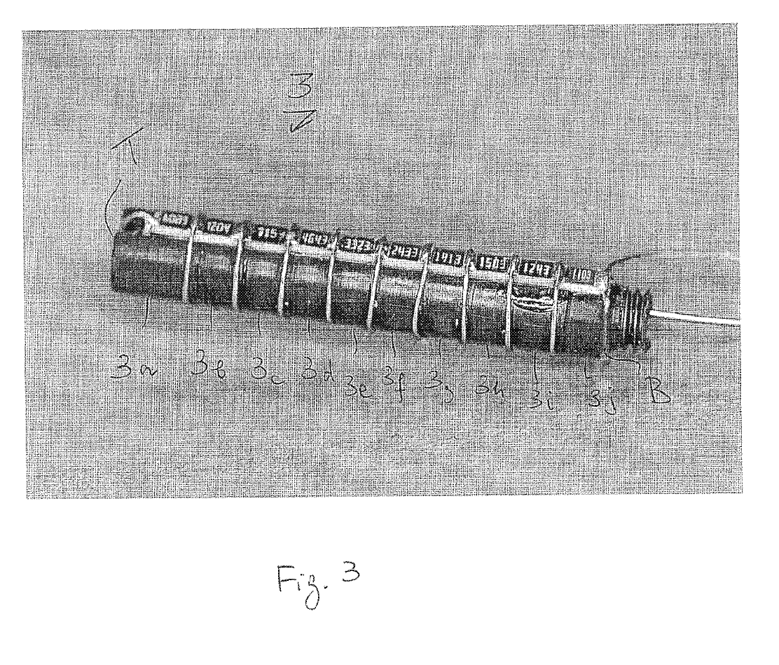

FIG. 3 presents in a schematic way an embodiment of the resistive body according to the invention.

### DETAILED DESCRIPTION

FIG. 1 presents in a schematic way an embodiment of a cross-section of the spherical ionization chamber according to the invention. The ionization chamber 10 is a so-called spherical ionization chamber, wherein the inner spherical electrode 2, having the radius rₐ is concentrically arranged with respect to the outer spherical electrode 4 having the respective radius r_{b}. The inner spherical electrode 2 is connected by suitable wires 5, 6 to a voltage source 8. The lead wires 5, 6 carry the same potential but are different in function. The wire 5 provides the potential for the hollow resistive body 3 for enabling correction of the E-field. The wire 6 carries the ionization current which is to be measured. The top portion of the hollow resistive body 3 must be electrically isolated from the inner spherical electrode 2. The outside of the resistive body 3 has to be electrically isolated for preventing any space charge from leaking through the body 3. The hollow resistive body 3 may be manufactured from a limited number of individual resistors, from a slightly conductive material formed to a correct shape for obtaining a continuous variation in local resistance, or from a non-conductive pole covered with different purposefully provided layers of conductive material for obtaining a structure having a semi-continuous change in local resistance. The potential from the voltage source 8 is provided to the outer spherical electrode using connection 4a.

In accordance with the invention a hollow resistive body 3 is provided between the inner surface of the outer spherical electrode 4 and the inner spherical electrode 2. The resistive body 3 is adapted with a suitable set of variable resistances for screening the wires 5, 6 and for maintaining the radial potential between the inner electrode 2 and the outer electrode 4 which corresponds to an unperturbed situation. The wire 6 may comprise an amperemeter for retrieving an electrical signal characterizing the ionization within the chamber 10 during use. More details on the hollow resistive body 3 will be discussed with reference to FIG. 3.

The hollow resistive body 3 is electrically connected to the outer spherical electrode 4 at a base portion 9 of the body 3. The hollow resistive body 3 may be mechanically connected to the inner electrode 2 by means of a support member I using a highly isolating material for maintaining the radial orientation of the resistive body 2. It will be appreciated that the support member I is electrically isolated from both the inner electrode and wire 5 connecting the top of the resistive body to the voltage source 8.

It is also appreciated that the outside of the resistive body is electrically insulated from the environment.

The electrical resistance in the resistive body in according to the invention depends on the radius r along the resistive body. In order to derive the suitable local values of the resistances a system of charged conductors may be considered, because this is exactly what has to be mimicked by the resistor body 3.

This simplifies the system to an inner charged small sphere with a radius ‘a’ carrying a charge ‘q’, being located at the centre of a larger hollow conducting sphere with inner radius ‘b’.

The electric potential for this system of nested spheres is given by:

$$V ( r ) = {V}_{a} - \frac{{V}_{a} - {V}_{b}}{\frac{1}{{R}_{b}} - \frac{1}{{R}_{a}}} \cdot ( \frac{1}{r} - \frac{1}{{R}_{a}} ) \qquad ( 1 )$$

As the absolute potential is arbitrary, one may set V_{b}=0V so that:

$$V ( r ) = {V}_{a} \cdot {R}_{a} \cdot ( \frac{1 - \frac{{R}_{b}}{r}}{{R}_{a} - {R}_{b}} ) . \qquad ( 2 )$$

Accordingly, at a given r the local resistance of the resistive layer around the thin central body 3 should be inversely proportional to the distance from the centre. The electrical potential at point r along the pole can be regarded as the wiper of a potentiometer.

The resulting resistive ladder has to reproduce this potential at the nodes between the resistors. In en embodiment where the resistive pole is comprised of a finite number of N resistors, the voltage at the node N is given by

$${V}_{j} = \frac{{\sum }_{k = 1}^{j} {R}_{k}}{{\sum }_{k = 1}^{N} {R}_{k}} \cdot {V}_{a} . \qquad ( 3 )$$

The combination of (2) and (3) gives (N−1) non-trivial equations for the N unknown values of Rⱼ. So the solution to that set of linear equations gives the relative values of all resistors. To obtain absolute values for all resistors and extra equation has to be added that sets the total current through the resistors.

The power dissipation in the resistive pole should be limited. With a typical driving voltage of 1000V and a resistive pole of total 10⁷ Ω the pole current would be limited to 100 micro ampere and the dissipated power to 100 mW.

The physical size of the resistors that is chosen determines the maximum values of N. Of course, the larger N, the better the approximation is of the node voltages to the real potential. Another approximation arrives from the limited choice of commercially available resistance values. For example for rₐ=2.5 mm and r_{b}=25 mm and a total resistance of about 10⁷ Ω, the following commonly available resistance values may be used:

R1=107 kOhm

R2=124 kOhm

R3=150 kOhm

R5=243 kOhm

R6=332 kOhm

R7=464 kOhm

R8=715 kOhm

R9=1 MOhm

R10=6 MOhm.

In another embodiment one may use layers of resistive coating instead of physical resistors. The layer thickness would change as a function of r in order to obtain the correct potential at every location r. Any material to manufacture high voltage electrical resistive components according to the present art can be used. Some non-limiting examples are: Carbon, metal films or slightly conductive polymers.

FIG. 2 presents in a schematic way an embodiment of a cut-away of the spherical ionization chamber according to the invention. In this view only a lower half 4a of the outer ionization chamber is shown. The resistive body 3 is connected at its base portion B to the inner surface of the outer ionization chamber 4a. The top portion T of the resistive body 3 is provided adjacent the inner electrode (not shown for clarity).

In accordance with the invention the resistive body 3 is provided with a series of individual resistors 3a, . . . 3n, wherein the value of a resistor arranged at the top portion is continuously decreasing to a lower value 3n.

It is also possible to provide a variation in dimension of the resistive body for achieving the result of a continuously varying resistance. For example, a cross-sectional dimension of the resistive body 3 at the top portion T may be larger than a cross-sectional dimension of the resistive body at the base portion. In this case the resistive body may be manufactured from the same material, as the difference in the local resistance will be attributed to a local difference in a volume of the material. A suitable material for manufacturing the resistive body is carbon, metal film or a slightly conductive polymer.

FIG. 3 presents in a schematic way an embodiment of the resistive body 3 according to the invention. It this embodiment the resistive body 3 comprises portions of the individual resistances 3a, 3b, 3c, 3d, 3e, 3f, 3g, 3h, 3i, 3j. It will be appreciated, however, that a different number of the resistive elements may be used. The local resistance 3a at the top portion of the resistive body is larger that the local resistance 3j at the base portion of the resistive body 3. Preferably, the values of the individual resistances depend inverse proportionally to the distance r from the centre of the ionization chamber.

While specific embodiments have been described above, it will be appreciated that the invention may be practiced otherwise than as described. The descriptions above are intended to be illustrative, not limiting. Thus, it will be apparent to one skilled in the art that modifications may be made to the invention as described in the foregoing without departing from the scope of the claims set out below.

1. An ionization chamber comprising an inner spherical electrode, an outer spherical electrode, a space between the inner spherical electrode and the outer spherical electrode, and a resistive hollow body, having a top and a base, provided in the space between the inner spherical electrode and the outer spherical electrode, wherein electrical connections to the inner spherical electrode and electrical connection to the top of a resistive hollow body are electrostatically screened by that same resistive hollow body having a continuously varied local resistance along its axis.

2. The ionization chamber according to claim 1, wherein the resistive body has a tapered rod shape.

3. The ionization chamber according to claim 1, wherein the continuously varied local resistance is adapted to enable a substantially undisturbed radial potential between the inner spherical electrode and the outer spherical electrode.

4. The ionization chamber according to claim 3, wherein a value of the local resistance at the top is larger than a value of the local resistance at the base of the resistive body.

5. The ionization chamber according to claim 1, wherein the top of the resistive body is connected to the inner spherical electrode by an insulator.

6. The ionization chamber according to claim 1, wherein the resistive body extends substantially radially between the outer electrode and the inner electrode.

7. A method for manufacturing an ionization chamber, comprising the steps of:
providing an inner spherical electrode, an outer spherical electrode, a space between the inner spherical electrode and the outer spherical electrode and a hollow resistive body, the resistive body having a top and a base portion, in said space;
screening an electrical connection to the inner spherical electrode and to the top of the hollow resistive body using the same hollow resistive body having a continuously varied local resistance, wherein said resistive body is radially arranged in said space between an inner surface of the outer spherical electrode and the inner spherical electrode.

8. The method according to claim 7, wherein the resistive body has a larger dimension at its base portion on the outer spherical electrode and a smaller dimension at its top near the inner spherical electrode.

9. The method according to claim 7, wherein the continuously varied local resistance is adapted to enable a substantially radial equipotential distribution between the inner spherical electrode and the outer spherical electrode.

10. The method according to claim 9, wherein a value of the resistance at the top is larger than a value of the resistance at the base of the resistive body.

11. The method according to claim 7, wherein the top of the resistive body is connected to the inner spherical electrode by an insulator.
